(19) United States
(12) Patent Application Publication
(10) Pub. No.: US 2026/0223220 A1
(43) Pub. Date: Jul. 30, 2026

(54) PROCESSING A CONNECTION REQUEST BY A CPU IN A CELL-FREE MASSIVE MIMO NETWORK

(71) Applicant: Telefonaktiebolaget LM Ericsson (publ), Stockholm (SE)

(72) Inventors: Marx Miguel MIRANDA DE FREITAS, Belem (BR); Andre Mendes CAVALCANTE, Indaiatuba SP (BR); Maria Valéria MARQUEZINI, Indaiatuba SP (BR); Daynara Dias SOUZA, Belem (BR); Gilvan Soares BORGES, Belem (BR); Roberto Menezes RODRIGUES, Belem (BR); João C. Weyl Albuqerque COSTA, Belem (BR); Luca VALCARENGHI, Pisa (IT); Igor ALMEIDA, Indaiatuba SP (BR)

(21) Appl. No.: 19/121,626

(22) PCT Filed: Oct. 19, 2022
(86) PCT No.: PCT/IB2022/060045

§ 371 Date: Apr. 16, 2025

(51) Int. Cl. H04W 76/15; H04W 48/02; H04W 60/04

(52) U.S. Cl. CPC H04W 76/15; H04W 48/02; H04W 60/04

(57) ABSTRACT

Methods and apparatus are provided. In an example, a method in a first processing apparatus of processing a connection request from a first User Equipment (UE) is provided. The first processing apparatus processes signals for one or more first Access Points (APs). The method comprises receiving a connection request for the first UE to connect to one of the one or more first APs, and determining whether an identifier of the first UE is associated with the first processing apparatus and/or one of the one or more first APs. The method also comprises, if the identifier of the first UE is not associated with the first processing apparatus and/or one of the one or more first APs, determining whether a number of further UEs served by the one or more first APs is below a threshold number, wherein the further UEs each comprise a UE that has an identifier that is not associated with the first processing apparatus and/or one of the one or more first APs; and if the number of further UEs is below the threshold number, serving the first UE.

### TECHNICAL FIELD

Example embodiments of this disclosure relate to systems and methods for processing a connection request from a user equipment (UE).

### BACKGROUND

The ever-increasing demand for data and quality of service (QoS) has been driving the enhancement of mobile communication networks. Regarding the networks of the fifth generation (5G) and beyond, cell-free massive MIMO (Multiple-Input and Multiple-Output) networks stand as one of the leading candidates' solutions envisaged for meeting future 15 demands [1]. Composed of a large set of access points (APs) spread out in the coverage area, these networks allow a user-equipment (UE) to transmit and receive signals simultaneously from several APs located in different geographical positions. Consequently, they can provide a more uniform spectral efficiency (SE) and better coverage probability than co-located massive MIMO [2].

State-of-the-art cell-free massive MIMO solutions work on a network composed of many APs linked by fronthaul to central processing units (CPUs). Each CPU coordinates an individual subset of APs and communicates with other CPUs through backhaul. Additionally, the network operates in a user-centric (UC) fashion such that each UE connects to a subset of APs, following a decision criterion (e.g., channel gain or QoS). Consequently, partially overlapping AP clusters are created, and the network can achieve scalability [2].

Despite the performance of UC systems, the strategy of centralizing the AP clusters around the UE may lead the network to demand intense inter-CPU coordination among the CPUs. The subset of APs serving each UE can comprise APs linked by fronthaul to different CPUs. Consequently, the AP clusters will not only be composed of different APs but can also have many CPUs. Therefore, the CPUs will need to exchange signals to inter-coordinate several AP clusters.

Inter-CPU coordination will not be a limiting factor for small-scale networks. On the other hand, it will be a bottleneck for coherent transmission in wider-scale networks with more APs and UEs [3]. In other words, the more UEs that are in the network, the more UEs that are connected to each CPU and need to be inter-coordinated, and the more APs, the larger the number of different CPUs there are in each AP cluster. In these scenarios, inter-CPU coordination will grow proportionally to the number of UEs and APs, which can impair the feasibility of UC systems for large deployments. In this regard, reducing inter-CPU coordination is an important task to improve the performance of UC cell-free systems. Furthermore, strategies to mitigate inter-CPU coordination while avoiding large reduction in spectral efficiency (SE) are crucial.

Reference [3] considers a cell-free network composed of several smaller cell-centric networks, with each cell being a static cluster. The authors exploit a hybrid approach between cell-centric and UC by letting the AP selection process be a function of the UE location in the coverage area. Therefore, the UEs inside a static cluster perform the AP selection considering only the APs inside the cell-centric area. The UEs located at the cluster edges perform AP selection without any restriction.

Solutions for reducing inter-CPU coordination as in [3] do not present a way to avoid the spectral efficiency (SE) decreasing. The disclosed strategies can reduce inter-CPU coordination, but at the cost of decreasing the SE, more than ten times in some scenarios. Furthermore, the proposed solutions prioritize prioritizes edge UEs over those inside a static cell-centric cluster.

### SUMMARY

Examples of this disclosure may have certain advantages. For example, examples of this disclosure may provide methods that result in high spectral efficiency, high energy efficiency, scalability, finite complexity, low computation complexity and/or less backhaul traffic.

One aspect of the present disclosure provides a method in a first processing apparatus of processing a connection request from a first User Equipment (UE), wherein the first processing apparatus processes signals for one or more first Access Points (APs). The method comprises receiving a connection request for the first UE to connect to one of the one or more first APs, and determining whether an identifier of the first UE is associated with the first processing apparatus and/or one of the one or more first APs. The method further comprises, if the identifier of the first UE is not associated with the first processing apparatus and/or one of the one or more first APs, determining whether a number of further UEs served by the one or more first APs is below a threshold number, wherein the further UEs each comprise a UE that has an identifier that is not associated with the first processing apparatus and/or one of the one or more first APs. If the number of further UEs is below the threshold number, the method comprises serving the first UE.

An additional aspect of the present disclosure provides method in a system, wherein the system comprises a first processing apparatus, one or more first Access Points (APs) and a first User Equipment (UE), wherein the first processing apparatus processes signals for one or more first APs. The method comprises sending, by the first UE, a connection request to connect to one of the one or more first APs, and determining, by the first processing apparatus, whether an identifier of the first UE is associated with the first processing apparatus and/or one of the one or more first APs. The method also comprises, if the identifier of the first UE is not associated with the first processing apparatus and/or one of the one or more first APs, determining, by the first processing apparatus, whether a number of further UEs served by the one or more first APs is below a threshold number, wherein the further UEs each comprise a UE that has an identifier that is not associated with the first processing apparatus and/or one of the one or more first APs. If the number of further UEs is below the threshold number, the method comprises serving, by the first processing apparatus, the first UE.

A further aspect of the present disclosure provides a first processing apparatus for processing a connection request from a first User Equipment (UE), wherein the first processing apparatus processes signals for one or more first Access Points (APs). The apparatus comprises a processor and a memory. The memory contains instructions executable by the processor such that the apparatus is operable to receive a connection request for the first UE to connect to one of the one or more first APs and determine whether an identifier of the first UE is associated with the first processing apparatus and/or one of the one or more first APs. The me memory contains instructions executable by the processor such that the apparatus is operable to, if the identifier of the first UE is not associated with the first processing apparatus and/or one of the one or more first APs, determine whether a number of further UEs served by the one or more first APs is below a threshold number, wherein the further UEs each comprise a UE that has an identifier that is not associated with the first processing apparatus and/or one of the one or more first APs; and if the number of further UEs is below the threshold number, serve the first UE.

A still further aspect of the present disclosure provides system comprising a first processing apparatus, one or more first Access Points (APs) and a first User Equipment (UE), wherein the first processing apparatus processes signals for one or more first APs. The system is configured to send, by the first UE, a connection request to connect to one of the one or more first APs; determine, by the first processing apparatus, whether an identifier of the first UE is associated with the first processing apparatus and/or one of the one or more first APs; if the identifier of the first UE is not associated with the first processing apparatus and/or one of the one or more first APs, determine, by the first processing apparatus, whether a number of further UEs served by the one or more first APs is below a threshold number, wherein the further UEs each comprise a UE that has an identifier that is not associated with the first processing apparatus and/or one of the one or more first APs; and if the number of further UEs is below the threshold number, serve, by the first processing apparatus, the first UE.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of a network 100, such as for example a user-centric cell-free massive MIMO network employing multiple processing apparatus;

FIG. 2 shows the network of FIG. 1 including a number of UEs connected to the network;

FIG. 3 is a flow chart of an example of a method 300 in a first processing apparatus of processing a connection request from a first User Equipment;

FIG. 4 shows an example of a system according to examples of this disclosure;

FIG. 5 is a flow chart of an example of a method performed by the system of FIG. 4;

FIG. 6 is a flow chart of another example of a method in a first processing apparatus of processing a connection request from a first User Equipment;

FIG. 7 shows another example of a method in a first processing apparatus of processing a connection request from a first User Equipment;

FIG. 8 shows the average SE and average EE versus the number of User Equipments in a simulation of example methods of this disclosure;

FIG. 9 shows an example of the impacts on inter-CPU coordination of example methods of this disclosure; and

FIG. 10 is a schematic of an example of an apparatus for processing a connection request from a first User Equipment.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

Embodiments of this disclosure provide example methods that reduce coordination between processing apparatus in UC cell-free systems as compared to earlier systems, while avoiding large drops of spectral efficiency. In this disclosure, the terms processing apparatus and CPU are used interchangeably, and in some examples a processing apparatus or CPU may comprise one or more co-located processing apparatus, CPUs or other data processing devices.

Proposed examples may assume that each CPU in a network can serve only a limited number of inter-coordinated UEs. Here, an inter-coordinated UE is a UE that is associated with (e.g. connected to) APs that are connected to different CPUs via fronthaul. In some examples, the method includes two procedures: (1) the UE performs an arbitrary AP selection strategy, and (2) the CPUs can accept, reject, or drop the connection of potentially inter-coordinated UEs with some APs, in some examples based on their channel conditions. In some examples, any new potentially inter-coordinated UE is evaluated after the CPU reaches its maximum number of inter-coordinated UEs. Then, only the ones presenting the best channel conditions are served, and the other ones are dropped or their connection requests rejected. As this strategy can in some examples reduce the number of UEs served by some APs, the proposed solution can decrease the computational complexity associated with channel estimation, precoding, and combination vectors.

Advantages provided by examples of this disclosure may include one or more of the following:
(1) High SE: proposed examples may reduce inter-CPU coordination while avoiding a substantial degradation of SE in a UC cell-free massive MIMO network. For example, a fine-tuning algorithm performed at the CPU may allow APs to serve inter-coordinated UEs presenting the stronger channel quality (e.g. channel gain) in their vicinities. Consequently, the APs may allocate more power to the UEs presenting the best channel conditions, leading to better use of power resources. However, this does not significantly affect the SE of the UEs with the worst channel quality. Since this process may be performed in the entire network in some examples, subsets of APs may also surround the worst UEs and allocate power to them.
(2) High energy efficiency (EE): proposed examples may reduce the number of UEs that each AP serves, decreasing traffic-dependent power on fronthaul links, while avoiding a significant degradation in SE. Consequently, the energy efficiency of the network may improve since the network may provide almost the same SE while consuming less power.
(3) Scalability and finite complexity: proposed examples may be based on a fine-tuning scheme in which the CPUs exploit a strategy to drop or keep connections of inter-coordinated UEs with some APs. In some examples, the number of inter-coordinated UEs that a CPU can serve is limited and does not change even if the number of UEs goes to infinity.
(4) Less computational complexity to perform channel estimation and to compute the precoding and combining vectors: proposed examples may allow CPUs to drop the connection of inter-coordinated UEs with some APs. This may reduce the number of UEs each AP serves and the average number of APs serving each UE. Consequently, the computational complexity of performing channel estimation and computing the precoding and combining vectors decreases, as it is proportional to these quantities.
(5) Less traffic in backhaul for inter-CPU coordination and lesser complex scalars exchanged with the fronthaul: in proposed examples, the number of inter-coordinated UEs served by each CPU is limited and independent of the number of UEs in the network. Therefore, the maximum amount of backhaul traffic becomes independent of the total number of UEs for inter-CPU coordination. Furthermore, since the number of UEs each AP serves and the average number of APs serving each UE decreases with proposed examples, the number of complex scalars exchanged with the fronthaul may also be reduced.

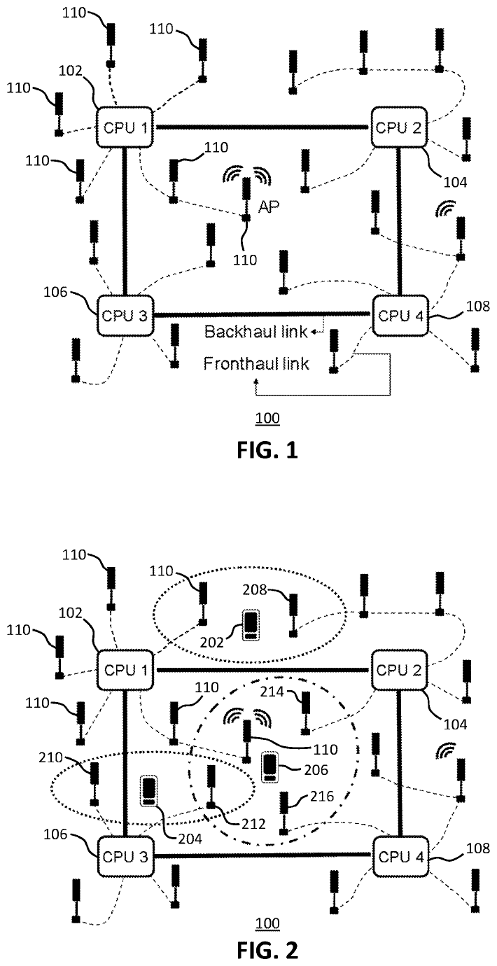

FIG. 1 shows an example of a network 100, such as for example a user-centric (UC) cell-free massive MIMO network employing multiple processing apparatus (also referred to as CPUs). The network 100 includes four CPUs 102, 104, 106 and 108, though in other examples the network may include any number of CPUs. The CPUs are interconnected via backhaul, though in some examples CPUs may not be interconnected directly and instead may be interconnected via one or more other CPUs and/or other network nodes or network infrastructure (not shown).

The example network includes one or more access points (APs) connected via fronthaul to each CPU. For example, CPU 102 is connected to six APs 110. Similarly, CPU 104 is connected to five APs, CPU 106 is connected to four APs and CPU 108 is connected to five APs.

FIG. 2 shows the network of FIG. 1 including a number of UEs connected to the network. Specifically, the network 100 shown in FIG. 2 shows three UEs 202, 204 and 206 connected to the network, though in other examples there may be any number of UEs. UE 202 is connected to an AP 110 connected to CPU 102 as well as AP 208 connected to CPU 104. UE 204 is connected to APs 210 and 212 connected to CPU 106. UE 206 is connected to AP 212 connected to CPU 106, AP 214 connected to CPU 104 and AP 216 connected to CPU 216. In other examples, any UE may be connected to any number of one or more APs, and each AP may be connected to any CPU via fronthaul.

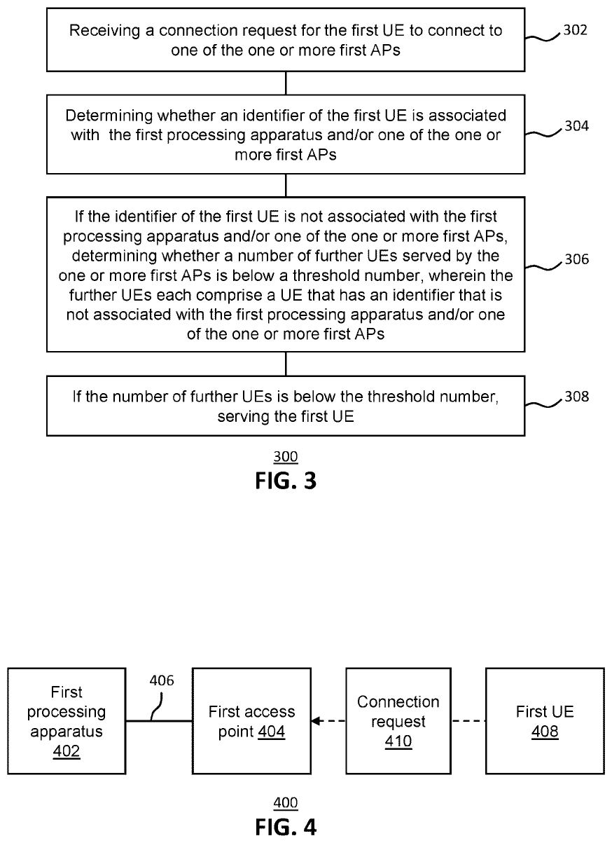

FIG. 3 is a flow chart of an example of a method 300 in a first processing apparatus of processing a connection request from a first User Equipment (UE). The method may be performed in a network, such as for example the network 100 shown in FIG. 1 or 2, and may be performed by a processing apparatus or CPU in a network, such as for example the CPU 102, 104, 106 and/or 108. The first processing apparatus processes signals for one or more first Access Points (APs). That is, for example, the first processing apparatus is connected to the one or more first APs via fronthaul.

The method 300 comprises, in step 302, receiving a connection request for the first UE to connect to one of the one or more first APs. For example, the connection request may be received by one of the first APs and forwarded to the first processing apparatus. Next, in step 304, the method 300 comprises determining whether an identifier of the first UE is associated with the first processing apparatus and/or one of the one or more first APs. For example, the identifier may have been previously provided to, sent to and/or assigned by the first UE, and this identifier may have been sent to the UE and/or assigned by the first processing apparatus or one of the first APs, or otherwise may be associated with the first processing apparatus and/or one of the first APs. Thus, in some examples, the method 300 may comprise, before determining whether an identifier of the first UE is associated with the first processing apparatus and/or one of the one or more first APs, assigning and/or sending the identifier to the first UE. In some examples, the identifier of the UE identifies the first processing apparatus as a “coordinator processing apparatus” or “coordinating CPU” for the first UE, which is described in more detail later in this disclosure. In some examples, the identifier may be included in or identified by the connection request.

In step 304 of the method 300, if the identifier of the first UE is not associated with the first processing apparatus and/or one of the one or more first APs, it is determined whether a number of further UEs served by the one or more first APs is below a threshold number, wherein the further UEs each comprise a UE that has an identifier that is not associated with the first processing apparatus and/or one of the one or more first APs. For example, the first UE, whose identifier is not associated with the first processing apparatus and/or one of the one or more first APs, is an “inter-coordinated UE” that is (or is requesting to be) connected to APs that are connected to different processing apparatus via fronthaul. In some examples, the identifier may be associated with a different processing apparatus and/or an AP connected to the different processing apparatus. In some such examples, the different processing apparatus may be the “coordinator processing apparatus” or “coordinating CPU” for the first UE.

Step 308 of the method 300 comprises, if the number of further UEs is below the threshold number, serving the first UE. That is, for example, if the first processing apparatus is serving a number of “inter-coordinated UEs” that is below a threshold number, the first UE will be served even if the first UE is an inter-coordinated UE (i.e. a UE that is connected to APs connected to different processing apparatus or CPUs).

Examples of this disclosure may thus control the maximum number of inter-coordinated UEs that are served by each processing apparatus or CPU in the network. For example, if the threshold number is reached by a processing apparatus, and another inter-coordinated UE attempts to connect to an AP connected to that processing apparatus, the processing apparatus can take actions to prevent the number of inter-coordinated UEs served by that processing apparatus from increasing beyond the threshold number. For example, the processing apparatus may reject connection requests from inter-coordinated UEs, or may disconnect from one or more UEs being served (such as for example one with the weakest signal quality, signal strength, channel gain etc.) and allow the first UE to connect and be served by the processing apparatus.

Thus, in some examples, the method 300 may comprise, if it is determined in step 306 that the number of further UEs is equal to or above the threshold number, determining, based on a channel quality of a channel between the one or more first APs and each of a plurality of UEs that comprise the first UE and UEs served by the one or more APs, a UE with a lowest channel quality of the plurality of UEs. If the first UE is not the UE with the lowest channel quality, a connection with the UE with the lowest channel quality may be dropped, and the first UE served. This may ensure for example that the number of inter-connected UEs that are served by the first processing apparatus does not exceed the threshold number. The method 300 may also include, if the first UE is the UE with the lowest channel quality, rejecting the connection request from the first UE. Furthermore, the method 300 may in some examples also comprise preventing the first UE from connecting to any of the one of the one or more first APs after rejecting the connection request from the first UE, as the first processing apparatus may be aware that connection requests from the first UE will be rejected. Thus, subsequent requests from the first UE to join any of the one or more first APs (i.e. those connected to the first processing apparatus) may be rejected. In some examples, the channel quality may be indicated by any suitable metric such as for example one or more of channel gain, signal strength of a signal between the first UE and an AP, signal to noise ratio (SNR), signal to interference and noise ratio (SINR), reference signal received power (RSRP), reference signal received quality (RSRQ) and/or any other suitable indication of channel quality between the first UE and an AP.

In some examples, there is a phase for estimating the channel gains. For example, the UE sends pilot signals (e.g. signals already known by the UE and AP) to the AP over different time instants. Then, the AP estimates the covariance matrix of the received signal based on the received pilots. The channel quality (e.g. channel gain) is then computed as the trace of the covariance matrix normalized by the number of antennas in each AP.

In some examples, determining whether an identifier of the first UE is associated with the first processing apparatus and/or one of the one or more first APs in step 306 comprises determining whether the first UE will be served by one or more further APs, wherein one or more further processing apparatus processes signals for the one or more further APs. That is, for example, this comprises determining whether a processing apparatus different to the first processing apparatus is the coordinating CPU or coordinating processing apparatus for the UE. The further UEs may for example comprise UEs that are also served by one or more further APs, wherein one or more further processing apparatus processes signals for the one or more further APs.

FIG. 4 shows an example of a system 400 that includes first processing apparatus 402, one or more first Access Points (APs) (one first access point 404 is shown) and a first User Equipment (UE) 406. The first processing apparatus 402 processes signals for one or more first APs including the first AP 404, which may be connected to the first processing apparatus via fronthaul 408 for example.

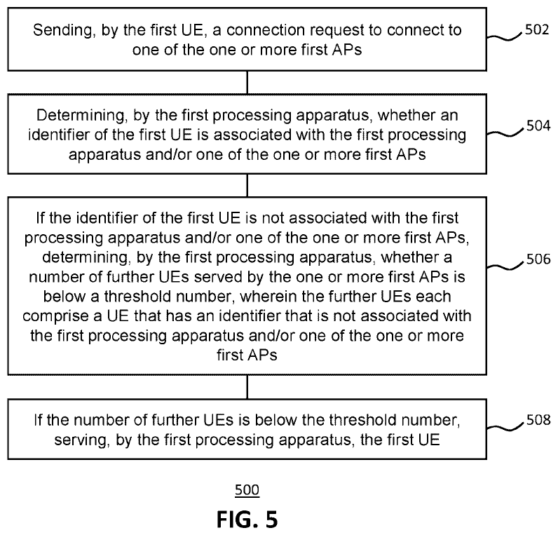

FIG. 5 is a flow chart of an example of a method 500 performed by the system of FIG. 4. The method 500 comprises, in step 502, sending, by the first UE, a connection request to connect to one of the one or more first APs. The connection request 410 is shown in FIG. 4 being sent by the first UE 408 to the first AP 404. Step 504 of the method 500 comprises determining, by the first processing apparatus, whether an identifier of the first UE is associated with the first processing apparatus and/or one of the one or more first APs. Step 506 comprises, if the identifier of the first UE is not associated with the first processing apparatus and/or one of the one or more first APs, determining, by the first processing apparatus, whether a number of further UEs served by the one or more first APs is below a threshold number, wherein the further UEs each comprise a UE that has an identifier that is not associated with the first processing apparatus and/or one of the one or more first APs. Step 508 of the method comprises, if the number of further UEs is below the threshold number, serving, by the first processing apparatus, the first UE.

In some examples, the first processing apparatus (e.g. the first processing apparatus 402 shown in FIG. 4) performs any of the examples the method 300 described above.

In some examples, the method 500 includes steps and alternatives similar to those described above relating to the method 300 of FIG. 3. Thus, for example, the method 500 may in some examples, determining whether an identifier of the first UE is associated with the first processing apparatus and/or one of the one or more first APs comprises determining whether the identifier of the first UE was assigned by and/or sent to the first UE by the first processing apparatus and/or one of the one or more first APs. The method may also in some examples comprise determining, by the first processing apparatus that the identifier of the first UE was assigned by and/or sent to the first UE by the first processing apparatus and/or one of the one or more first APs, and wherein the method comprises, before determining whether an identifier of the first UE is associated with the first processing apparatus and/or one of the one or more first APs, assigning and/or sending the identifier to the first UE.

The method may in some examples comprise, if the number of further UEs is equal to or above the threshold number, determining, by the first processing apparatus, based on a channel quality of a channel between the one or more first APs and each of a plurality of UEs that comprise the first UE and UEs served by the one or more APs, a UE with a lowest channel quality of the plurality of UEs. If the first UE is not the UE with the lowest channel quality, the method 500 may comprise dropping, by the first processing apparatus, a connection with the UE with the lowest channel quality, and serving the first UE. If the first UE is the UE with the lowest channel quality, the method 500 may in some examples comprise rejecting, by the first processing apparatus, the connection request from the first UE. The method 500 may in some examples also comprise preventing, by the first processing apparatus, the first UE from connecting to any of the one of the one or more first APs after rejecting the connection request from the first UE. This may comprise for example rejecting subsequent requests from the first UE to join any of the one or more first APs.

In some examples, the method 500 comprises determining whether an identifier of the first UE is associated with the first processing apparatus and/or one of the one or more first APs comprises determining whether the first UE will be served by one or more further APs, wherein one or more further processing apparatus processes signals for the one or more further APs. The first processing apparatus is connected to the one or more further processing apparatus via backhaul in some examples. In some examples, the further UEs comprise UEs that are also served by one or more further APs, wherein one or more further processing apparatus processes signals for the one or more further APs.

The signals for the one or more first APs may comprise for example signals received by the one or more first APs and/or signals transmitted by the one or more first APs. In some examples, the connection request identifies the identifier of the first UE.

Particular example embodiments will now be described for illustrative purposes.

In some example embodiments, each processing apparatus or CPU in a network, such as for example the network 100 shown in FIGS. 1 and 2, may individually coordinate (e.g. process) signals coming from the APs linked to it by fronthaul. The AP clusters of each UE (that is, for example, the APs serving each UE) can comprise APs belonging to different CPUs, although some UEs may be connected to one or more APs that are connected via fronthaul to a single processing apparatus in some examples.

In some examples of this disclosure, one or more of the following assumptions may be made:
The network is composed of K single-antenna UEs, L APs equipped with N antennas each, and multiple CPUs, where each CPU can serve only a limited number of inter-coordinated UEs, denoted as Kᵢₙₜ. This may be the threshold number referred to above;
Each CPU has access to the channel statistics of the UEs (e.g. channel quality, correlation matrices, channel gain coefficients etc.) and knows which APs are linked to it by fronthaul;
Each AP may use a finite number of orthogonal pilot sequences τₚ, which is independent of K, and each AP can serve only a limited number of UEs, denoted as Uₘₐₓ, to achieve scalability;
The CPUs communicate with each other through backhaul links;
The network infrastructure (e.g., fronthaul, backhaul and core network) is assumed to be error-free and able to support the data traffic.

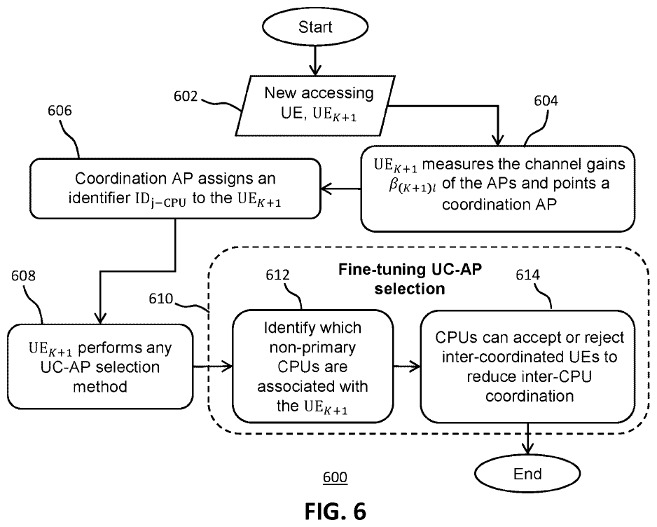

In an example method, such as for example a method of processing a connection request from a first UE, two procedures are used. In an example, the first procedure comprises receiving an identifier and performing UC-AP selection, and comprises the following steps, with reference to FIG. 6, which shows a flow chart of an example of a method 600 in a first processing apparatus of processing a connection request from a first User Equipment (UE):
1) When a new UE (denoted as UE_{K+1}) enters the network (step 602 in FIG. 6), it measures the large-scale fading coefficients β_{(K+1)l} of the APs in its vicinity, for l={1, . . . ,L}(step 604). Then, it claims a coordination AP to ensure it will connect to at least one AP (step 604). The coordination AP may be for example connected to the first processing apparatus referred to above by fronthaul in some examples. To select a coordination AP, the UE following process may be used in some examples:
   a. To select a coordination AP, the UE_{K+1} requests connection to the available APs. These may be the ones serving less than Uₘₐₓ UEs in some examples;
   b. The available APs reply to the UE_{K+1} request, and the UE chooses the AP with the largest channel quality (e.g. channel gain β_{(K+1)t}) to be its coordination AP.
2) The coordination AP assigns an identifier ID_{j-CPU} to the UE_{K+1} in step 606 of the method 600 of FIG. 6. This may in some examples be the identifier of the first UE referred to above. This identifier may be used in the following manner in some examples:
   a. It indicates the CPU in which the coordination AP is linked by fronthaul, which will also be assumed as the CPU that coordinates the UE_{K+1}.
   b. The j-th CPU of index ID_{j-CPU} may consider the UE_{K+1} as a non-inter-coordinated UE, which means that the UE_{K+1} will not be dropped by this CPU. In other words, as in a cellular system where each UE is part of a cell, in this example, each UE has a primary CPU, referred to herein as coordinating processing apparatus or coordinator CPU, which considers this UE as a non-inter-coordinated UE.
   c. The remaining CPUs will use the ID_{j-CPU} to identify the UE_{K+1} as a potentially inter-coordinated UE (e.g. the identifier is not associated with and was not assigned or sent by the remaining CPUs). Then, they will decide to accept or reject the UE_{K+1}. If the UE_{K+1} is accepted, it will be one of the UEs that the CPU inter-coordinates.
3) The UE_{K+1} performs any UC-AP selection strategy (step 608).
4) The next step 610 is fine-tuning the UC-AP selection, which includes identifying in step 612 which non-primary CPUs are associated with the UE_{K+1}, and in step 614 each CPU accepting or rejecting a connection request from an inter-coordinated UE (e.g. depending on whether a first UE has an identifier that not associated with those CPUs) to reduce inter-CPU coordination. These steps 612 and 614 may be performed at the CPUs. It is considered, for example, that each CPU can accept or reject potentially inter-coordinated UEs (i.e., ID_{i-CPU}≠ID_{j-CPU}) to mitigate inter-CPU coordination. Thus, in some examples, each CPU can serve only a limited number of inter-coordinated UEs, denoted as Kᵢₙₜ. Hence, the maximum number of inter-coordinated UEs served by a CPU becomes independent of the number of UEs K. That is, for example, the CPU will inter-coordinate at most Kᵢₙₜ inter-coordinated UEs even if the number of UEs K goes to infinity.

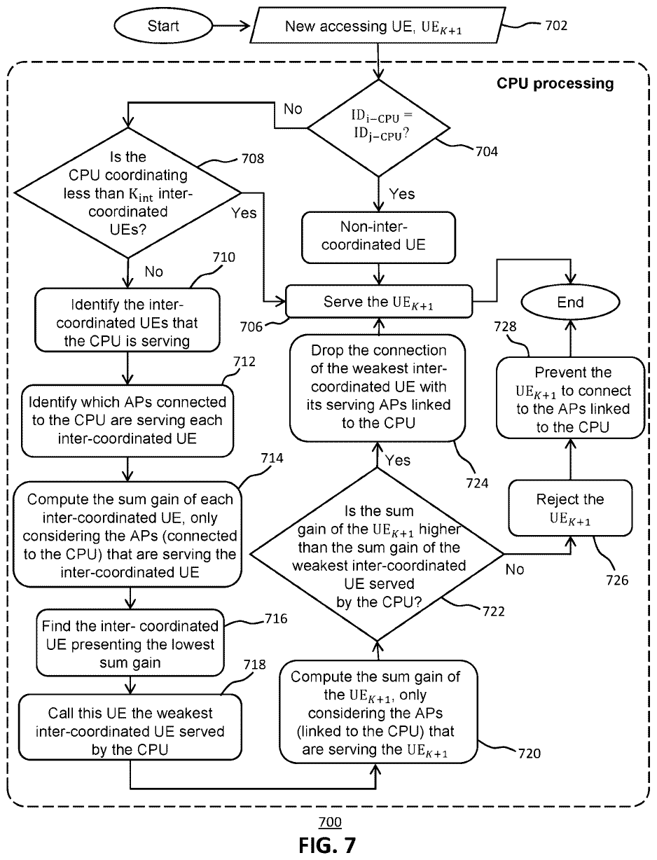

FIG. 7 shows another example of a method 700 in a first processing apparatus (also referred to as a CPU) of processing a connection request from a first UE. The method includes the following steps:
1) On a new UE accessing the network (step 702), the CPU analyses the UE identity in step 704 to determine if it is a non-inter-coordinated (ID_{i-CPU}=ID_{j-CPU}) or a potentially inter-coordinated (ID_{i-CPU}≠ID_{j-CPU}) UE. In the case of a non-inter-coordinated UE, the CPU will serve it (step 706). In case of a potentially inter-coordinated UE, the UE_{K+1} can still be served by the CPU as long as one of the following two conditions is satisfied:
   a. The CPU is serving less than Kᵢₙₜ inter-coordinated UEs (determined in step 708), in which case the UE is served by the CPU (step 706); or
   b. The sum of the channel gain of the UE_{K+1} (a non-limiting example of channel quality between the UE and the CPU or AP) is greater than the sum of the channel gain of the weakest inter-coordinated UE connected to the CPU. These sums are performed considering only the APs serving each inter-coordinated UE in the CPU.
2) To find the weakest inter-coordinated UE connected to it, the CPU performs the following:
   a. The CPU identifies the inter-coordinated UEs that it is already serving (step 710), and which APs (connected to the CPU) are serving each inter-coordinated UE (step 712).
   b. The CPU sums on a linear scale the channel gains of each inter-coordinated UE with respect to the APs that serve them on the CPU (step 714).
   c. The one presenting the lowest channel sum gain (determined in step 716) will be referred to as the weakest inter-coordinated UE (step 718).
3) In case of the UE_{K+1} presents a channel sum gain (computed in step 720) larger than the weakest inter-coordinated UE (determined in step 722), the connections to the AP(s) that serve the weakest inter-coordinated UE on the CPU are dropped in step 724, and the UE_{K+1} is served (step 706). Otherwise, the UE_{K+1} is rejected (step 726) and the CPU prevents the UE_{K+1} from connecting the APs linked to it (step 728).

In order to evaluate the performance of example methods proposed herein, simulations in a reference scenario have been performed, and results obtained as follows.

The propagation model adopted for the simulations is the Urban Micro (UMi) path-loss model defined in 3GPP TR 38.901 V6.1.0. The parameter-values used in the simulations are presented in Table 1 below.

TABLE 1
Parameters for the UMi path-loss model.

| Parameter | Value | |
|---|---|---|
| Effective environment height, h_{E} | 1.0 | m |
| Shadow fading standard deviation, σ_{SF} | 4 | dB |
| Antenna height AP, UE, h_{AP} , h_{UE} | 11.65 m, 1.65 m | |
| RX noise figure, NF | 8 | dB |

In order to generate the results, Monte Carlo simulations are carried out. To compute the Signal to Interference and Noise Ratio (SINR) and the spectral efficiency (SE), the expressions adopted in this disclosure are the same as the ones employed in [2]. The simulations focus on downlink channels and the main parameters are defined in Table 2 below. A distributed network implementation is considered, where each AP performs the channel estimation and processes the data signals locally. The precoding vectors are computed following the Local Partial Minimum Mean Square Error (LP-MMSE) proposed in [2]. To compute energy efficiency (EE), the modeling and parameters proposed in [1] are considered. The method proposed in [2] to perform AP selection is considered. This one is a scalable UC-AP clustering based on the traditional approach that cell-free networks employ CPUs presenting infinite inter-CPU coordination capacity.

TABLE 2
Parameters and models employed in the simulations.

| Parameter | Value | |
|---|---|---|
| Protocol | TDD | |
| Channel fading models | Correlated Rician | |
| | and Rayleigh | |
| Simulation area | 1 km × 1 km | |
| Number of APs L, Number of UEs K | 100, 25 | |
| Number of antenna elements per AP, N | 1 | |
| Number of CPUs | 4 | |
| Average number of APs per CPU | 25 | |
| Coherence interval τ_{c}, | 200 samples, 10 | |
| number of orthogonal pilot sequences τₚ | samples | |
| Carrier Frequency f, Bandwidth | 3.5 GHZ, 100 MHz | |
| AP total Tx power | 200 | mW |
| UE total Tx power | 100 | mW |

| Max number of UEs served by an AP, Uₘₐₓ | τₚ |
|---|---|
| Max number of inter-coordinated | 10 |
| UEs that a CPU can serve, Kᵢₙₜ | |

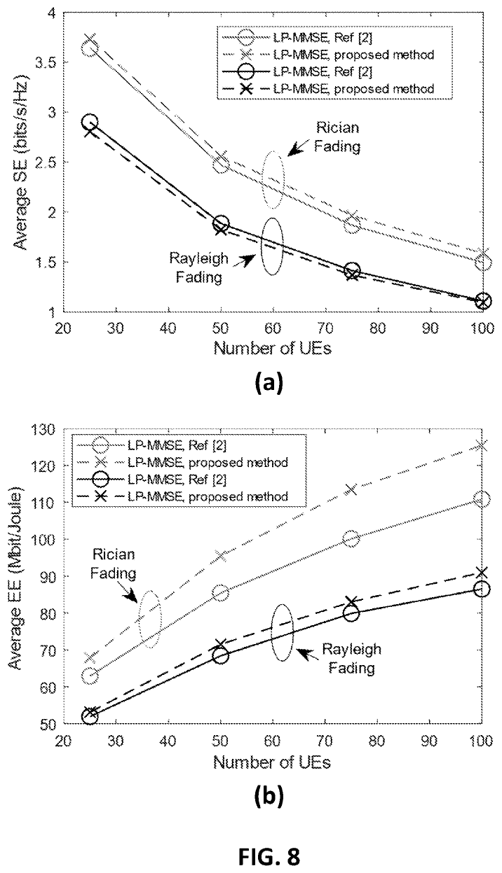

In order to evaluate the performance of the proposed method, FIG. 8 shows the average SE (FIG. 8(a)) and average EE (FIG. 8(b)) versus the number of UEs in a simulation of example methods of this disclosure, for Rician and Rayleigh fading channels. In this example, it is considered that Kᵢₙₜ=10, there is a varying number of UEs (K), and 100 APs are deployed in the coverage area. It is noted from FIG. 8(a) that for a channel modeled as a Rician Fading (i.e., with a line of sight, LOS, component), proposed methods can provide a slight improvement in the SE while providing gains for the EE, as FIG. 8(b) shows. The EE gains can be up to 12.82% for 100 UEs, and the SE increase is related to the reduction of interference in the APs. As one of the effects of proposed methods is to reduce the number of UEs that the AP serves (as Table 3 below illustrates), the average number of interfering signals in each AP is also reduced. This reduction helps local precoding techniques such as LP-MMSE as their interference mitigation capabilities decrease with the number of UEs that the AP serves [2]. However, one can note small decreases in SE for proposed methods when the LOS components are blocked (Rayleigh fading channels), as FIG. 8(a) depicts. Moreover, the EE gains are also smaller.

The same behaviors remain by varying the number of APs (L) from 20 to 200. Keeping the number of UEs (K) fixed at 25 and considering Kᵢₙₜ=10, proposed methods slightly increase the average SE (for Rician fading channels) and provide gains in the average EE. On the other hand, it also presents small SE decreases for Rayleigh fading channels.

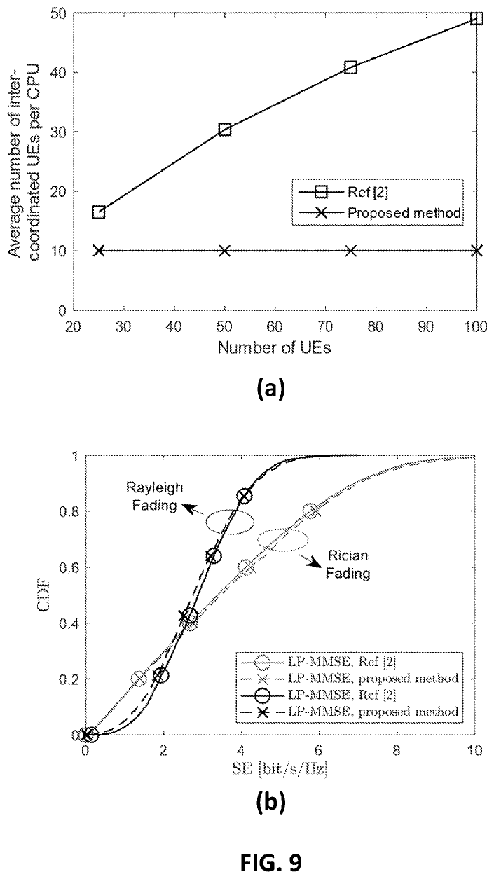

The impacts on inter-CPU coordination of example methods of this disclosure can be observed in FIG. 9(a). It is possible to note that even if the number of UEs grows, the average number of inter-coordinated UEs served by the CPUs is the same, which makes the backhaul traffic independent of the total number of UEs for inter-CPU coordination. This differs from a UC cell-free system without presenting any control for inter-CPU coordination. For instance, the average number of inter-coordinated UEs per CPU grows proportionally to the number of UEs for the approach reported in [2], as shown in FIG. 9(a). FIG. 9(b) shows the cumulative distribution function (CDF) versus SE for a further comparison. It is noted that with proposed methods, not only significant degradations of the average SE are avoided, but also the CDF.

Regarding the computational complexity of performing channel estimation and computing the precoding and combining vectors, proposed methods can reduce the average number of UEs served by an AP and the average number of APs serving each UE, as Table 3 below illustrates. According to [2], these quantities are critical for computational complexity, and the number of complex scalars exchanged with the fronthaul.

TABLE 3
Average number of UEs served by an AP and average number of APs serving
each UE. Parameters setting: L = 100 APs, K = 25 UEs, Kᵢₙₜ = 10.

| | Average number | | Average number | |
|---|---|---|---|---|
| | of APs serving | Standard | of UEs served by | Standard |
| Method | each UE | deviation | an AP | Deviation |
| Ref [2] | 22.5635 | 1.0967 | 5.604 | 0.085 |
| Proposed method | 17.52 | 0.69 | 4.38 | 0.44 |

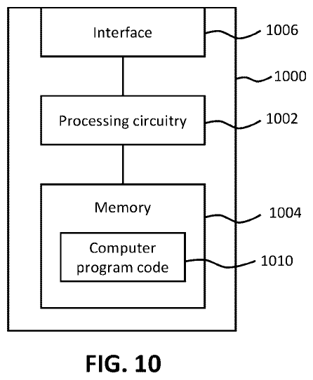

FIG. 10 is a schematic of an example of an apparatus 1000 for processing a connection request from a first User Equipment (UE). The apparatus 1000 comprises processing circuitry 1002 (e.g. one or more processors) and a memory 1004 in communication with the processing circuitry 1002. The memory 1004 contains instructions, such as computer program code 1010, executable by the processing circuitry 1002. The apparatus 1000 also comprises an interface 1006 in communication with the processing circuitry 1002. Although the interface 1006, processing circuitry 1002 and memory 1004 are shown connected in series, these may alternatively be interconnected in any other way, for example via a bus. In one embodiment, the memory 1004 contains instructions executable by the processing circuitry 1002 such that the apparatus 1000 is operable/configured to receive a connection request for the first UE to connect to one of the one or more first APs; determine whether an identifier of the first UE is associated with the first processing apparatus and/or one of the one or more first APs; if the identifier of the first UE is not associated with the first processing apparatus and/or one of the one or more first APs, determine whether a number of further UEs served by the one or more first APs is below a threshold number, wherein the further UEs each comprise a UE that has an identifier that is not associated with the first processing apparatus and/or one of the one or more first APs; and if the number of further UEs is below the threshold number, serve the first UE. In some examples, the apparatus 1000 is operable/configured to carry out the method 300 described above with reference to FIG. 3.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

### REFERENCES

1. Hien Ngo et al., “On the Total Energy Efficiency of Cell-Free Massive MIMO,” in IEEE Transactions on Green Communications and Networking, March 2018.
2. Emil Bjornson et al., “Scalable Cell-Free Massive MIMO Systems,” in IEEE Transactions on Communications, July 2020.
3. Vida Ranjbar et al., “Cell-free mMIMO Support in the O-RAN Architecture: A PHY Layer Perspective for 5G and Beyond Networks,” in IEEE Communications Standards Magazine, April 2022

1. A method in a first processing apparatus of processing a connection request from a first User Equipment, UE wherein the first processing apparatus processes signals for one or more first Access Points, APs the method comprising:
receiving a connection request for the first UE to connect to one of the one or more first APs;
determining whether an identifier of the first UE is associated with at least one of the first processing apparatus and one of the one or more first APs;
if the identifier of the first UE is not associated with at least one of the first processing apparatus and one of the one or more first APs, determining whether a number of further UEs served by the one or more first APs is below a threshold number, wherein the further UEs each comprise a UE that has an identifier that is not associated with at least one of the first processing apparatus and one of the one or more first APs; and
if the number of further UEs is below the threshold number, serving the first UE.

2. The method of claim 1, wherein determining whether an identifier of the first UE is associated with at least one of the first processing apparatus and one of the one or more first APs comprises determining whether the identifier of the first UE was at least one of assigned by and sent to the first ULE by at least one of the first processing apparatus and one of the one or more first APs.

3. The method of claim 2, comprising determining that the identifier of the first UE was at least one of assigned by and sent to the first UE by at least one of the first processing apparatus and one of the one or more first APs, and wherein the method comprises, before determining whether an identifier of the first UE is associated with at least one of the first processing apparatus and one of the one or more first APs, at least one of assigning and sending the identifier to the first UE.

4. The method of claim 1, wherein the method comprises, if the number of further UEs is equal to or above the threshold number:
determining, based on a channel quality of a channel between the one or more first APs (and each of a plurality of UEs that comprise the first UE and UEs served by the one or more APs, a UE with a lowest channel quality of the plurality of UEs;
if the first UE is not the UE with the lowest channel quality, dropping a connection with the UE with the lowest channel quality, and serving the first UE.

5. The method of claim 4, wherein, if the first UE is the UE with the lowest channel quality, rejecting the connection request from the first UE.

6. The method of claim 5, comprising preventing the first UE from connecting to any of the one of the one or more first APs after rejecting the connection request from the first UE.

7. The method of claim 6, wherein preventing the first UE from connecting to any of the one of the one or more first APs comprises rejecting subsequent requests from the first UE to join any of the one or more first APs.

8. The method of claim 1, wherein determining whether an identifier of the first UE is associated with at least one of the first processing apparatus and/Of and one of the one or more first APs comprises determining whether the first UE will be served by one or more further APs, wherein one or more further processing apparatus processes signals for the one or more further APs.

9. The method of claim 8, wherein the first processing apparatus is connected to the one or more further processing apparatus via backhaul.

10. The method of claim 1, wherein the one or more first APs are connected to the first processing apparatus via fronthaul.

11. The method of claim 1, wherein the further UEs comprise UEs that are also served by one or more further APs, wherein one or more further processing apparatus processes signals for the one or more further APs.

12. The method of claim 1, wherein the signals for the one or more first APs comprise signals received by at least one of the one or more first APs and signals transmitted by the one or more first APs.

13. The method of claim 1, wherein the connection request identifies the identifier of the first UE.

14. A method in a system, wherein the system comprises a first processing apparatus, one or more first Access Points, APs, and a first User Equipment, UE, wherein the first processing apparatus processes signals for one or more first APs, the method comprising:
sending, by the first UE, a connection request to connect to one of the one or more first APs;
determining, by the first processing apparatus, whether an identifier of the first UE is associated with at least one of the first processing apparatus and one of the one or more first APs;
if the identifier of the first UE is not associated with at least one of the first processing apparatus and one of the one or more first APs, determining, by the first processing apparatus, whether a number of further UEs served by the one or more first APs is below a threshold number, wherein the further UEs each comprise a UE that has an identifier that is not associated with at least one of the first processing apparatus and one of the one or more first APs; and
if the number of further UEs is below the threshold number, serving, by the first processing apparatus, the first UE.

15-26. (canceled)

27. A first processing apparatus for processing a connection request from a first User Equipment, UE, wherein the first processing apparatus processes signals for one or more first Access Points, APs, the apparatus comprising a processor and a memory, the memory containing instructions executable by the processor such that the apparatus is operable to:
receive a connection request for the first UE to connect to one of the one or more first APs;
determine whether an identifier of the first UE is associated with at least one of the first processing apparatus and one of the one or more first APs;
if the identifier of the first UE is not associated with at least one of the first processing apparatus and one of the one or more first APs, determine whether a number of further UEs served by the one or more first APs is below a threshold number, wherein the further UEs each comprise a UE that has an identifier that is not associated with at least one of the first processing apparatus and one of the one or more first APs; and
if the number of further UEs is below the threshold number, serving the first UE.

28. The apparatus of claim 27, wherein the memory contains instructions executable by the processor such that the apparatus is operable to perform the method of claim 2.

29-32. (canceled)

33. The method according to claim 14, wherein said method further comprises the steps according to claim 2.
